(19) United States
(12) Patent Application Publication
(10) Pub. No.: US 2025/0264823 A1
(43) Pub. Date: Aug. 21, 2025

(54) IMAGE FORMING APPARATUS AND IMAGE FORMING METHOD

(71) Applicant: FUJIFILM Business Innovation Corp., Tokyo (JP)

(72) Inventors: Ryo NAGAI, Kanagawa (JP); Yasuo KADOKURA, Kanagawa (JP); Yosuke TSURUMI, Kanagawa (JP); Moegi IGUCHI, Kanagawa (JP)

(73) Assignee: FUJIFILM Business Innovation Corp., Tokyo (JP)

(21) Appl. No.: 18/951,593

(22) Filed: Nov. 18, 2024

(30) Foreign Application Priority Data
Feb. 20, 2024 (JP) 2024-024070

(51) Int. Cl. G03G 9/093; G03G 9/083

(52) U.S. Cl. CPC G03G 9/09385; G03G 9/0833; G03G 9/0838; G03G 9/09314; G03G 9/09342; G03G 2215/0607

(57) ABSTRACT

An image forming apparatus is an image forming apparatus of a trickle development type, in which a two-component developer containing a toner and a carrier A is accommodated in a developing machine and a toner is supplied together with a supply carrier B in response to a toner consumed by development, in which the carrier A has a magnetic core material A and a resin coating layer A coating the magnetic core material A, where the resin coating layer A contains no metal oxide particles, and the supply carrier B has a magnetic core material B and a resin coating layer B coating the magnetic core material B, where the resin coating layer B contains metal oxide particles.

### CROSS-REFERENCE TO RELATED APPLICATIONS

This application is based on and claims priority under 35 USC 119 from Japanese Patent Application No. 2024-024070 filed Feb. 20, 2024.

### BACKGROUND

### (i) Technical Field

The present invention relates to an image forming apparatus and an image forming method.

### (ii) Related Art

JP1999-223960A discloses a replenishing developer for use in a developing method of performing development while replenishing a replenishing developer in a case of developing a latent image of a latent image carrier by using a developer containing a two-component developer consisting of a toner and a carrier, the replenishing developer containing the carrier and the toner at a blending proportion of 1 to 30 parts of the toner with respect to 1 part of the carrier in terms of a weight ratio, in which the carrier has the same electric resistance as a carrier that is previously accommodated in the developing machine but imparts a higher charge amount to the toner.

JP2023-5605A discloses a carrier having core material particles and a coating layer coating the core material particles, in which the coating layer contains a resin, inorganic fine particles, and an aluminum catalyst, and the aluminum catalyst contains one or two or more aluminum chelate compounds selected from the group consisting of diisopropoxy aluminum ethyl acetoacetate, isopropoxy bisethyl acetoacetate aluminum, aluminum triethyl acetoacetate, and aluminum dibutoxyethyl acetoacetate.

### SUMMARY

Aspects of non-limiting embodiments of the present disclosure relate to an image forming apparatus and an image forming method that has excellent fogging suppressing property, as compared with a case where resin coating layers of both a carrier A and a supply carrier B contain metal oxide particles.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above-described object include the following aspect.

According to an aspect of the present disclosure, there is provided an image forming apparatus of a trickle development type, in which a two-component developer containing a toner and a carrier A is accommodated in a developing machine and a toner is supplied together with a supply carrier B in response to a toner consumed by development, in which the carrier A has a magnetic core material A and a resin coating layer A coating the magnetic core material A, where the resin coating layer A contains no metal oxide particles, and the supply carrier B has a magnetic core material B and a resin coating layer B coating the magnetic core material B, where the resin coating layer B contains metal oxide particles.

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment.

### DETAILED DESCRIPTION

Hereinafter, exemplary embodiments of the present invention will be described in detail with reference to the accompanying drawings.

In a case where the amount of each component in a composition is mentioned in the present specification, and there are two or more kinds of substances corresponding to each component in the composition, unless otherwise specified, the amount of each component means the total amount of two or more kinds of the substances present in the composition.

In the present specification, a numerical range described using “to” represents a range including numerical values listed before and after “to” as the minimum value and the maximum value respectively.

In the present specification, the term “step” includes not only an independent step but a step that is not clearly distinguished from other steps as long as the intended purpose of the step is achieved.

In the present specification, an “electrostatic charge image developing carrier” is also referred to as “carrier”, an “electrostatic charge image developing toner” is also referred to as “toner”, and an “electrostatic charge image developer” is also referred to as a “developer”.

### Image Forming Apparatus

The image forming apparatus according to the present exemplary embodiment is an image forming apparatus of a trickle development type, in which a two-component developer containing a toner and a carrier A is accommodated in a developing machine and a toner is supplied together with a supply carrier B in response to a toner consumed by development, in which the carrier A has a magnetic core material A and a resin coating layer A coating the magnetic core material A, where the resin coating layer A contains no metal oxide particles, and the supply carrier B has a magnetic core material B and a resin coating layer B coating the magnetic core material B, where the resin coating layer B contains metal oxide particles.

In the image forming apparatus of the related art, a developing device, so-called trickle type has been introduced in which a developing device that suppresses a change in charge amount and stabilizes an image density by adding a carrier together with a toner consumed by development and gradually replacing the carrier in the developing machine is used.

In the image forming apparatus of the related art using the trickle type, it is assumed that, in a case where the supply carrier is added, a deteriorated carrier and a non-deteriorated supply carrier are discharged at a proportion of 1:1, and the deteriorated carrier is gradually replaced with the supply carrier at a constant ratio.

In the image forming apparatus of the related art, particularly in a case of low image quality density and low number of sheets printing in which the toner consumption amount is extremely low, time for a contaminated carrier to be discharged is required, that may deteriorate an initial decrease in charge of the developer, and thus fogging may occur.

In the image forming apparatus according to the present exemplary embodiment, since the carrier A accommodated in the developing machine has the magnetic core material A and the resin coating layer A coating the magnetic core material A, and does not contain metal oxide particles in the resin coating layer A, and the supply carrier B has the magnetic core material B and the resin coating layer B coating the magnetic core material B, and contains metal oxide particles in the resin coating layer B, a difference in fluidity of carriers occurs by adding the supply carrier B that is a high-reliability carrier having high fluidity to the carrier A that is a deteriorated carrier having low fluidity, the carrier A having poor fluidity is selectively discharged, the decrease in charge of the developer is suppressed, and the toner fogging is suppressed.

Hereinafter, a configuration of the image forming apparatus according to the present exemplary embodiment will be described in detail.

### Carrier A and Supply Carrier B

The image forming apparatus according to the present exemplary embodiment is an image forming apparatus of a trickle development type, that accommodates the two-component developer containing the toner and the carrier A in a developing machine, supplies a toner with the supply carrier B in response to a toner consumed by development.

In addition, the above-described carrier A has the magnetic core material A and the resin coating layer A coating the magnetic core material A, and does not contain metal oxide particles in the resin coating layer A1; and the above-described supply carrier B has the magnetic core material B and the resin coating layer B coating the magnetic core material B, and contains metal oxide particles in the resin coating layer B.

In the present exemplary embodiment, unless otherwise specified, the term “carrier” refers to both the carrier A and the supply carrier B, the term “magnetic core material” refers to both the magnetic core material A and the magnetic core material B, and the term “resin coating layer” refers to both the resin coating layer A and the resin coating layer B.

### Resin Coating Layer

The above-described carrier A has the resin coating layer A and does not contain metal oxide particles in the resin coating layer A, and the above-described supply carrier B has the resin coating layer B and contains metal oxide particles in the resin coating layer B.

Examples of a resin configuring the resin coating layer include a styrene acrylic acid copolymer; a polyolefin-based resin such as polyethylene or polypropylene; a polyvinyl-based or polyvinylidene-based resins such as polystyrene, an acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride vinyl acetate copolymer; a straight silicone resin consisting of an organosiloxane bond or a modified product thereof; a fluororesin such as polytetrafluoroethylene, polyvinyl fluoride, polyvinylidene fluoride, or polychlorotrifluoroethylene; polyester; polyurethane; polycarbonate; an amino resin such as a urea formaldehyde resin; and an epoxy resin.

From the viewpoint of image density stability, for example, the above-described resin coating layer preferably contains an acrylic resin having an aliphatic cyclic structure and an amino group, and more preferably contains an acrylic resin that has a constitutional unit having an aliphatic cyclic structure and a constitutional unit having an amino group.

Preferred examples of the aliphatic cyclic structure include a cycloalkyl group, and more preferred examples thereof include a cyclohexyl group.

Specific examples of the acrylic resin having a cyclohexyl group include a homopolymer of an acrylic monomer having a cyclohexyl group and a copolymer of an acrylic monomer having a cyclohexyl group and another monomer.

Examples of the acrylic monomer having a cyclohexyl group include cyclohexyl acrylate and cyclohexyl methacrylate.

In addition, examples of the constitutional unit having an aliphatic cyclic structure include a constitutional unit derived from cyclohexyl (meth)acrylate.

From the viewpoint of image density stability, for example, the acrylic resin that has a constitutional unit having an aliphatic cyclic structure preferably contains 80% by mass or more of the constitutional unit having an aliphatic cyclic structure.

In addition, preferred examples of the acrylic monomer having an amino group include dialkylaminoalkyl (meth)acrylate, and more preferred examples thereof include dimethylaminoethyl (meth)acrylate.

From the viewpoint of image density stability, for example, the acrylic resin that has a constitutional unit having an amino group preferably contains 0.05% by mass or more and 5% by mass or less of the constitutional unit having an amino group, and more preferably contains 0.1% by mass or more and 2% by mass or less of the constitutional unit having an amino group.

The resin coating layer B contains metal oxide particles.

Examples of the metal oxide particles include titania, silica, alumina, zinc oxide, tin oxide, antimony-doped tin oxide, indium-doped tin oxide, and zinc oxide-doped aluminum.

The metal oxide particles may be contained alone, or in combination of two or more kinds thereof.

Among these, from the viewpoint of fogging suppressing property, the metal oxide particles are, for example, preferably at least one kind of particles selected from the group consisting of silica, titania, and alumina, and more preferably silica particles.

From the viewpoint of fogging suppressing property, a volume-average particle size D of the metal oxide particles is, for example, preferably 1 nm or more and 100 nm or less, more preferably 3 nm or more and 85 nm or less, still more preferably 5 nm or more and 70 nm or less, and particularly preferably 6 nm or more and 30 nm or less. In a case of being within the above-described range, the supply carrier B has an excellent contamination suppressing effect and excellent fluidity due to appropriate burial of the metal oxide particles in the resin coating layer and suppression of desorption, and thus the supply carrier B has an excellent fogging suppressing property.

The volume-average particle size of the metal oxide particles can be controlled, for example, by various conditions in a case of producing the metal oxide particles.

The volume-average particle size D of the metal oxide particles is measured as follows.

Particles to be measured are measured for a particle size distribution using COULTER COUNTER LS13 (manufactured by Beckman Coulter, Inc.). Based on the measured particle size distribution, a volume cumulative distribution is drawn from the small diameter side with respect to the divided particle size range (channel) to measure the particle size distribution.

In the volume cumulative distribution drawn from the small diameter side, a particle size at a cumulative percentage of 50% is defined as the volume-average particle size D.

The volume-average particle size D of the metal oxide particles can also be obtained by analyzing a cross section of the magnetic particles. Specifically, the volume-average particle size D of the metal oxide particles is a value determined by obtaining an equivalent circle diameter of each of 100 metal oxide particles contained in the resin coating layer of the magnetic particles, and averaging the values. The analysis is carried out by observation with FE-SEM capable of high-resolution imaging. Examples thereof include “SU8010”, “Regulus 8100”, “Regulus 8220”, “Regulus 8230”, “Regulus 8240”, and “ULTRA55” of Regulus series manufactured by Hitachi High-Tech Corporation; and “JSM-IT800” manufactured by JEOL Ltd.

As a number-average particle size of inorganic particles contained in the resin coating layer, a volume-average particle size D of the inorganic particles measured by a laser diffraction/scattering type particle size distribution analyzer may be used.

The metal oxide particles contained in the resin coating layer may be metal oxide particles themselves, or particles obtained by performing a hydrophobization treatment on the surface of the metal oxide particles (may be referred to as base particles); but from the viewpoint of fogging suppressing property, for example, metal oxide particles which have been subjected to a surface treatment are preferable, and metal oxide particles in which the surface has been subjected to a hydrophobization treatment are more preferable.

The surface treatment of the metal oxide particles is performed, for example, by preparing a treatment liquid obtained by mixing the silicon-containing organic compound that is a hydrophobizing agent with a solvent, mixing the metal oxide particles with the treatment liquid under stirring, and further continuing the stirring. After the surface treatment, for the purpose of removing the solvent in the treatment liquid, a drying treatment is performed.

Examples of the silicon-containing organic compound used in the surface treatment for the metal oxide particles include an alkoxysilane compound, a silazane compound, and a silicone oil.

Examples of the alkoxysilane compound used in the hydrophobization treatment of the surface of the metal oxide particles include tetramethoxysilane, tetraethoxysilane; methyltrimethoxysilane, ethyltrimethoxysilane, propyltrimethoxysilane, butyltrimethoxysilane, hexyltrimethoxysilane, n-octyltrimethoxysilane, decyltrimethoxysilane, dodecyltrimethoxysilane, vinyltriethoxysilane, methyltriethoxysilane, ethyltriethoxysilane, butyltriethoxysilane, hexyltriethoxysilane, decyltriethoxysilane, dodecyltriethoxysilane, phenyltrimethoxysilane, o-methylphenyltrimethoxysilane, p-methylphenyltrimethoxysilane, phenyltriethoxysilane, benzyltriethoxysilane; dimethyldimethoxysilane, dimethyldiethoxysilane, methylvinyldimethoxysilane, methylvinyldiethoxysilane, diphenyldimethoxysilane, diphenyldiethoxysilane; and trimethylmethoxysilane and trimethylethoxysilane.

Examples of the silazane compound used in the hydrophobization treatment of the surface of the metal oxide particles include dimethyldisilazane, trimethyldisilazane, tetramethyldisilazane, pentamethyldisilazane, and hexamethyldisilazane.

Examples of the silicone oil used in the surface treatment for the metal oxide particles include silicone oils such as dimethylpolysiloxane, diphenylpolysiloxane, and phenylmethylpolysiloxane; and reactive silicone oils such as amino-modified polysiloxane, epoxy-modified polysiloxane, carboxyl-modified polysiloxane, carbinol-modified polysiloxane, fluorine-modified polysiloxane, methacryl-modified polysiloxane, mercapto-modified polysiloxane, and phenol-modified polysiloxane.

The solvent used for preparing the above-described treatment liquid is, for example, preferably an alcohol (for example, methanol, ethanol, propanol, or butanol) in a case where the silicon-containing organic compound is an alkoxysilane compound or a silazane compound, or preferably hydrocarbons (for example, benzene, toluene, normal hexane, and normal heptane) in a case where the silicon-containing organic compound is a silicone oil.

In the above-described treatment liquid, a concentration of the silicon-containing organic compound is, for example, preferably 1% by mass or more and 50% by mass or less, more preferably 5% by mass or more and 40% by mass or less, and still more preferably 10% by mass or more and 30% by mass or less.

The amount of the silicon-containing organic compound used in the surface treatment is, for example, preferably 1 part by mass or more and 50 parts by mass or less, more preferably 5 parts by mass or more and 40 parts by mass or less, and even more preferably 5 parts by mass or more and 30 parts by mass or less with respect to 100 parts by mass of the metal oxide particles.

From the viewpoint of fogging suppressing property, a content of the metal oxide particles in the resin coating layer B is, for example, preferably 5% by mass or more and 70% by mass or less, more preferably 10% by mass or more and 60% by mass or less, still more preferably 15% by mass or more and 50% by mass or less, and particularly preferably 20% by mass or more and 40% by mass or less with respect to the total mass of the resin coating layer B. In a case of being within the above-described range, the contamination suppressing effect is exhibited, a selective mechanism for discharging the deteriorated carrier in the developing machine is achieved, and the fogging suppressing property is more excellent.

In addition, from the viewpoint of fogging suppressing property, for example, the resin coating layer preferably contains resin particles.

From the viewpoint of fogging suppressing property, examples of the resin particles include melamine resin particles.

Furthermore, from the viewpoint of fogging suppressing property, for example, the resin coating layer preferably contains carbon black.

Among these, from the viewpoint of fogging suppressing property, for example, the resin coating layer A preferably contains carbon black and melamine resin particles.

In addition, from the viewpoint of fogging suppressing property, for example, the resin coating layer B preferably contains silica particles and melamine resin particles, and more preferably contains silica particles, carbon black, and melamine resin particles.

From the viewpoint of fogging suppressing property, a content of the resin particles in the resin coating layer B is, for example, preferably lower than the content of the metal oxide particles described above.

From the viewpoint of fogging suppressing property, the content of the resin particles in the resin coating layer is, for example, preferably 1% by mass or more and 50% by mass or less, more preferably 2% by mass or more and 40% by mass or less, even more preferably 5% by mass or more and 35% by mass or less, and particularly preferably 10% by mass or more and 32% by mass or less with respect to the total mass of the resin coating layer.

From the viewpoint of fogging suppressing property, a content of the carbon black in the resin coating layer is, for example, preferably lower than the content of at least one kind of particles selected from the group consisting of silica, titania, and alumina in the resin coating layer described above.

In addition, from the viewpoint of fogging suppressing property, the content of the carbon black in the resin coating layer is, for example, preferably lower than the content of the resin particles in the resin coating layer described above.

From the viewpoint of fogging suppressing property, the content of the carbon black in the resin coating layer is, for example, preferably 0.5% by mass or more and 50% by mass or less, more preferably 1% by mass or more and 40% by mass or less, still more preferably 2% by mass or more and 35% by mass or less, and particularly preferably 5% by mass or more and 32% by mass or less with respect to the total mass of the resin coating layer.

Examples of a method of forming the resin coating layer on the surface of the magnetic particles include a wet manufacturing method and a dry manufacturing method. The wet manufacturing method is a manufacturing method using a solvent that dissolves or disperses the resin configuring the resin coating layer. On the other hand, the dry manufacturing method is a manufacturing method that does not use the above-described solvent.

Specifically, examples of the wet manufacturing method include a dipping method of dipping the magnetic particles in a resin solution for forming a resin coating layer; a spray method of spraying the resin solution for forming a resin coating layer to the surface of the magnetic particles; a fluidized bed method of spraying the resin solution for forming a resin coating layer to the magnetic particles that are in a state of being fluidized in a fluidized bed; and a kneader coater method of mixing the magnetic particles with the resin solution for forming a resin coating layer in a kneader coater and removing solvents.

The resin solution for forming the resin coating layer used in the wet manufacturing method is prepared by dissolving or dispersing a resin and other components in a solvent. The solvent is not particularly limited as long as the solvent dissolves or disperses the resin, and for example, aromatic hydrocarbons such as toluene and xylene; ketones such as acetone and methyl ethyl ketone; ethers such as tetrahydrofuran and dioxane; and the like are used.

Examples of the dry manufacturing method include a method of heating a mixture of the magnetic particles and a resin for forming a resin coating layer in a dry state to form the resin coating layer. Specifically, for example, the magnetic particles and the resin for forming a resin coating layer are mixed together in a gas phase and melted by heating to form the resin coating layer.

A thickness of the resin coating layer is, for example, preferably 0.1 μm or more and 10 μm or less, and more preferably 0.3 μm or more and 5 μm or less.

An exposed proportion of the magnetic particles on the surface of the carrier is, for example, preferably 2% or more and 20% or less, more preferably 2% or more and 10% or less, and still more preferably 3% or more and 8% or less.

The exposed proportion of the magnetic particles on the surface of the carrier is determined by X-ray photoelectron spectroscopy (XPS) from the following method.

A target carrier and magnetic particles obtained by removing the resin coating layer from the target carrier are prepared. Examples of a method of removing the resin coating layer from the resin-coated magnetic particles include a method of removing the resin coating layer by dissolving resin components with an organic solvent, and a method of removing the resin coating layer by heating the carrier to approximately 800° C. to eliminate the resin components. The carrier and the magnetic particles excluding the resin coating layer are each used as a measurement sample, Fe (atomic %) is quantified by XPS, and (Fe of resin-coated magnetic particles)÷(Fe of magnetic particles)×100 is calculated to obtain the exposed proportion (%) of the magnetic particles.

The exposed proportion of the magnetic particles on the surface of the carrier can be controlled by the amount of the resin used for forming the resin coating layer, and as the amount of the resin relative to the amount of the magnetic particles is larger, the exposed proportion is smaller.

### Value of SiB/SiA

In a case where the above-described metal oxide particles are silica particles, from the viewpoint of fogging suppressing property, a value of a ratio SiB/SiA of a surface silica amount SiB of the supply carrier B to a surface silica amount SiA of the carrier A is, for example, preferably 1 or more and 8 or less, more preferably 1.2 or more and 5 or less, and particularly preferably 2 or more and 4 or less. In a case of being within the above-described range, the difference in fluidity between the carrier A and the supply carrier B in the developing machine occurs, and the deteriorated carrier A in the developing machine is selectively discharged.

As a method for adjusting the surface silica amounts of the carrier A and the supply carrier B described above, the amount of silica particles contained in the resin coating layer can be controlled, and as the amount of silica particles with respect to the resin is large, the surface silica amount of the carrier is large.

A method for measuring the surface silica amount of the carrier in the present disclosure is as follows.

The carrier is used as a sample and analyzed by X-ray photoelectron spectroscopy (XPS) under the following conditions, and the peak intensity of all elements is measured. Next, a ratio (atomic %) of Si is obtained from the peak intensity of all the obtained elements.
XPS device: manufactured by ULVAC-PHI, Inc., VersaProbe II
Etching gun: argon gun
Acceleration voltage: 5 kV
Emission current: 20 mA
Sputtering region: 2 mm×2 mm
Sputtering rate: 3 nm/min (in terms of SiO₂)

In addition, in a case of measuring the surface silica amount of the carrier in the developer, separation is performed by blow-off. Specifically, approximately 20 g of the developer is sampled, the toner is removed from the developer by blow-off, and only the carrier is isolated. The ratio (atomic %) of Si is obtained from the obtained carrier by X-ray photoelectron spectroscopy under the above-described conditions.

### Value of BETB/BETA

From the viewpoint of fogging suppressing property, a value of a ratio BETB/BETA of a BET specific surface area BETA of the carrier A to a BET specific surface area BETB of the supply carrier B is, for example, preferably 0.2 or more and 10 or less, more preferably 0.5 or more and 8 or less, and particularly preferably 1 or more and 5 or less. In a case of being within the above-described range, the difference in fluidity between the carrier A and the supply carrier B in the developing machine occurs, and the deteriorated carrier A in the developing machine is selectively discharged.

Examples of a method for adjusting the BET specific surface areas of the carrier A and the supply carrier B described above include a method of adjusting the BET specific surface area by the amount of carbon black and melamine resin particles with respect to the resin.

A method for measuring the BET specific surface area of the carrier in the present disclosure is as follows.

The BET specific surface area of the carrier is measured by a three-point nitrogen substitution method using a SA3100 specific surface area measurement device (manufactured by Beckman Coulter KK). Specifically, 5 g of the magnetic particles are put into a cell, deaeration treatment is performed at 60° C. for 120 minutes, and the three-point nitrogen substitution method is performed using a mixed gas of nitrogen and helium (30:70).

### Magnetic Particles

The magnetic particles are not particularly limited, and known magnetic particles used as a core material of the carrier are applied. Specific examples of the magnetic particles include particles of a magnetic metal such as iron, nickel, and cobalt; particles of a magnetic oxide such as ferrite and magnetite; resin-impregnated magnetic particles in which a porous magnetic powder is impregnated with a resin; and magnetic powder-dispersed resin particles in which a magnetic powder is dispersed in a resin.

As the magnetic particles in the present exemplary embodiment, for example, ferrite particles are suitable.

In the present exemplary embodiment, for example, it is preferable that the ferrite particles contain at least one compound selected from calcium oxide and strontium oxide. It is presumed that calcium oxide and strontium oxide are likely to be contained in the surface of the ferrite particles, and in a case where a calcium element or a strontium element is present within the surface of the ferrite particles, leakage of charge from the ferrite particles may be suppressed, that may allow the carrier surface to be charged to a high level. Such a carrier inhibits a toner from being charged to a low level in a developing device. As a result, the fogging is further suppressed, and fine line reproducibility is improved (for example, thickening, crushing, or blurring of fine lines is suppressed). The present effect is markedly exhibited in a case where high-concentration and high-density monochromatic images are repeatedly formed at a high speed and then low-density images of the same color are formed.

In the present exemplary embodiment, for example, the ferrite particles preferably contain at least one compound selected from calcium oxide and strontium oxide, and the total content of a calcium element and a strontium element is, for example, preferably 0.1% by mass or more and 2.0% by mass or less with respect to the total mass of the ferrite particles. In a case where the total content of the calcium element and the strontium element is 0.1% by mass or more with respect to the entire ferrite particles, charge leakage from the ferrite particles is efficiently suppressed. In a case where the total content of the calcium element and the strontium element is 2.0% by mass or less with respect to the entire ferrite particles, the crystal structure of the ferrite particles is organized, and the resistance and magnetic susceptibility are in an appropriate range. As a result, the fogging is further suppressed, and fine line reproducibility is improved (for example, thickening, crushing, or blurring of fine lines is suppressed).

From the above-described viewpoint, the total content of the calcium element and the strontium element with respect to the entire ferrite particles is, for example, preferably 0.1% by mass or more and 2.0% by mass or less, more preferably 0.2% by mass or more and 1.5% by mass or less, and still more preferably 0.5% by mass or more and 1.2% by mass or less.

In the present exemplary embodiment, the ferrite particles contain calcium oxide, and a content of the calcium element is, for example, preferably 0.2% by mass or more and 2.0% by mass or less with respect to the total mass of the ferrite particles. In a case where the content of the calcium element is 0.2% by mass or more with respect to the entire ferrite particles, the charge leakage from the ferrite particles is efficiently suppressed. In a case where the total content of the calcium element is 2.0% by mass or less with respect to the entire ferrite particles, the crystal structure of the ferrite particles is organized, and the resistance and magnetic susceptibility are in an appropriate range. As a result, the fogging is further suppressed, and fine line reproducibility is improved (for example, thickening, crushing, or blurring of fine lines is suppressed).

From the above-described viewpoint, the content of the calcium element with respect to the entire ferrite particles is, for example, preferably 0.2% by mass or more and 2.0% by mass or less, more preferably 0.5% by mass or more and 1.5% by mass or less, and still more preferably 0.5% by mass or more and 1.0% by mass or less.

In the present exemplary embodiment, the ferrite particles contain strontium oxide, and a content of the strontium element is, for example, preferably 0.1% by mass or more and 1.0% by mass or less with respect to the total mass of the ferrite particles. In a case where the content of the strontium element is 0.1% by mass or more with respect to the entire ferrite particles, the charge leakage from the ferrite particles is efficiently suppressed. In a case where the total content of the strontium element is 1.0% by mass or less with respect to the entire ferrite particles, the crystal structure of the ferrite particles is organized, and the resistance and magnetic susceptibility are in an appropriate range. As a result, the fogging is further suppressed, and fine line reproducibility is improved (for example, thickening, crushing, or blurring of fine lines is suppressed).

From the above-described viewpoint, the content of the strontium element with respect to the entire ferrite particles is, for example, preferably 0.1% by mass or more and 1.0% by mass or less, more preferably 0.4% by mass or more and 1.0% by mass or less, and still more preferably 0.5% by mass or more and 0.8% by mass or less.

The contents of the calcium element and the strontium element contained in the ferrite particles are measured by X-ray fluorescence analysis. The X-ray fluorescence analysis is performed on the ferrite particles by the following method.

Using an X-ray fluorescence spectrometer (manufactured by Shimadzu Corporation., XRF1500) under the conditions of X-ray output: 40 V/70 mA, measurement area: diameter of 10 mm, and measurement time: 15 minutes, qualitative analysis and quantitative analysis are performed. The element to be analyzed is selected based on the element detected by the qualitative analysis. Iron (Fe), manganese (Mn), magnesium (Mg), calcium (Ca), strontium (Sr), oxygen (O), and carbon (C) are generally selected. A mass proportion (%) of each element is calculated with reference to the separately created calibration curve data.

A volume-average particle size of the magnetic particles is, for example, preferably 10 μm or more and 500 μm or less, more preferably 20 μm or more and 180 μm or less, and still more preferably 25 μm or more and 60 μm or less.

As for a magnetic force of the magnetic particles, a saturation magnetization of the magnetic particles in a magnetic field of 3,000 Oe is 50 emu/g or more, for example, preferably 60 emu/g or more. The saturation magnetization is measured using a vibrating sample magnetometer VSMP10-15 (manufactured by TOEI INDUSTRY CO., LTD.). The measurement sample is packed in a cell having an inner diameter of 7 mm and a height of 5 mm and set in the aforementioned magnetometer. For the measurement, a magnetic field is applied and swept up to 3,000 Oe. Next, the applied magnetic field is reduced, and a hysteresis curve is created on recording paper. Saturation magnetization, residual magnetization, and coercive force are obtained from the data of the curve.

An electrical volume resistance (volume resistivity) of the magnetic particles is 105 Ω·cm or more and 109 Ω·cm or less, for example, preferably 10⁷ Ω·cm or more and 109 Ω·cm or less.

The electrical volume resistance (Ω·cm) of the magnetic particles is measured as follows. A measurement target is placed flat on the surface of a circular jig on which a 20 cm² electrode plate is disposed, such that the measurement target has a thickness of approximately 1 mm or more and 3 mm or less and forms a layer. The above-described 20 cm² electrode plate is placed on the layer such that the layer is sandwiched between the electrode plates. In order to eliminate voids between measurement targets, a load of 4 kg is applied onto the electrode plates arranged on the layer, and then the thickness (cm) of the layer is measured. Both the upper and lower electrodes of the layer are connected to an electrometer and a high-voltage power supply device. A high voltage is applied to both electrodes such that an electric field of 103.8 V/cm is generated, and the current value (A) flowing at this time is read. The volume resistivity is measured in an environment at a temperature of 20° C. and a humidity of 50% RH. An expression for calculating the electrical volume resistance (Ω·cm) of the measurement target is as follows.

$$R = E \times 20 / ( I - {I}_{0} ) / L$$

In the above expression, R represents an electrical volume resistance (Ω·cm) of the measurement target, E represents an applied voltage (V), I represents a current value (A), I₀ represents a current value (A) at an applied voltage of 0 V, and L represents a thickness of the layer (cm). The coefficient of 20 represents an area (cm²) of the electrode plate.

### Characteristics of Carrier

A volume-average particle size of the carrier is, for example, preferably 15 μm or more and 510 μm or less, more preferably 20 μm or more and 180 μm or less, and still more preferably 25 μm or more and 60 μm or less.

As for a magnetic force of the carrier, a saturation magnetization of the carrier in a magnetic field of 1,000 Oe is 40 emu/g or more, for example, preferably 50 emu/g or more. The measurement of the saturation magnetization described above is performed by sweeping up to a maximum of 1,000 Oe in the same manner as the measurement of the saturation magnetization of the magnetic particles.

A volume electrical resistance (25° C.) of the carrier is 1×10⁷ Ω·cm or more and 1×10¹⁵ Ω·cm or less, for example, preferably 1×10⁸ Ω·cm or more and 1×10¹⁴ Ω·cm or less and more preferably 1×10⁸ Ω·cm or more and 1×10¹³ Ω·cm or less. The measurement of the volume electrical resistance of the carrier is performed in the same manner as the measurement of the volume electrical resistance of the magnetic particles.

### Two-Component Developer

In the image forming apparatus according to the present exemplary embodiment, the two-component developer accommodated in the developing machine contains the toner and the carrier A.

In addition, the supply of the supply carrier B may be performed by the supply carrier B alone or as a two-component developer containing the toner and the supply carrier B, but for example, it is preferable to perform the supply of the supply carrier B as a two-component developer containing the toner and the supply carrier B.

The two-component developer accommodated in the developing machine is prepared by mixing the toner and the carrier A at an appropriate formulation proportion. The mixing ratio (mass ratio) between the toner and the carrier A, represented by toner: carrier, is, for example, preferably 1:100 to 30:100, and more preferably 3:100 to 20:100.

A trickle amount (=a content of the carrier in the two-component developer to be supplied) in a case of supplying the supply carrier B is not particularly limited, but from the viewpoint of fogging suppressing property, the trickle amount is, for example, preferably 1% by mass or more and 25% by mass or less, more preferably 2% by mass or more and less than 15% by mass, and particularly preferably 5% by mass or more and 10% by mass or less.

### Electrostatic Charge Image Developing Toner

As the toner, known toners are used without particular restriction. Examples thereof include a colored toner that contains toner particles containing a binder resin and a colorant, and an infrared-absorbing toner that uses an infrared absorber instead of a colorant. The toner may contain a release agent, various internal additives, an external additive, and the like.

### Binder Resin

Examples of the binder resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

As the binder resin, for example, a polyester resin is suitable. Examples of the polyester resin include known polyester resins.

The glass transition temperature (Tg) of the polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

A weight-average molecular weight (Mw) of the polyester resin is, for example, preferably 5,000 or more and 1,000,000 or less, and more preferably 7,000 or more and 500,000 or less. The number-average molecular weight (Mn) of the polyester resin is, for example, preferably 2,000 or more and 100,000 or less. The molecular weight distribution Mw/Mn of the polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC. HLC-8120GPC manufactured by Tosoh Corporation as a measurement device, TSKgel Super HM-M (15 cm) manufactured by Tosoh Corporation as a column, and tetrahydrofuran (THF) as a solvent. The weight-average molecular weight and the number-average molecular weight are calculated using a molecular weight calibration curve plotted using a monodisperse polystyrene standard sample from the measurement results.

The content of the binder resin with respect to the total amount of the toner particles is, for example, preferably 40% by mass or more and 95% by mass or less, more preferably 50% by mass or more and 90% by mass or less, and even more preferably 60% by mass or more and 85% by mass or less.

### Colorant

Examples of the colorant include pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

A content of the colorant is, for example, preferably 1% by mass or more and 30% by mass or less and more preferably 3% by mass or more and 15% by mass or less with respect to the total amount of the toner particles.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

### Other Additives

Examples of other additives include known additives such as a magnetic material, a charge control agent, and inorganic powder. The additives are incorporated into the toner particles as internal additives.

### Characteristics of Toner Particles and the Like

The toner particles may be toner particles that have a single-layer structure or toner particles having a so-called core/shell structure that is configured with a core portion (core particle) and a coating layer (shell layer) coating the core portion. The toner particles having a core/shell structure may, for example, be configured with a core portion that is configured with a binder resin and other additives used as necessary, such as a colorant and a release agent, and a coating layer that is configured with a binder resin.

The volume-average particle size (D50v) of the toner particles is, for example, preferably 2 μm or more and 10 μm or less, and more preferably 4 μm or more and 8 μm or less.

The volume-average particle size (D50v) of the toner particles is measured using COULTER MULTISIZER II (manufactured by Beckman Coulter, Inc.) and using ISOTON-II (manufactured by Beckman Coulter, Inc.) as an electrolytic solution. For measurement, a measurement sample in an amount of 0.5 mg or more and 50 mg or less is added to 2 ml of a 5% by mass aqueous solution of a surfactant (for example, preferably sodium alkylbenzene sulfonate) as a dispersant. The obtained solution is added to an electrolytic solution in a volume of 100 ml or more and 150 ml or less. The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

### External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO· SiO₂, K₂O. (TiO₂) n, Al₂O₃·2SiO₂, CaCO₃, MgCO₃, BaSO₄, and MgSO₄.

The surface of the inorganic particles as an external additive may have undergone, for example, a hydrophobization treatment. The hydrophobization treatment is performed, for example, by dipping the inorganic particles in a hydrophobizing agent. The hydrophobizing agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

The amount of the hydrophobizing agent is, for example, preferably 1 part by mass or more and 10 parts by mass or less with respect to 100 parts by mass of the inorganic particles.

Examples of the external additive also include resin particles (resin particles such as polystyrene, polymethylmethacrylate, and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 5% by mass or less, and more preferably 0.01% by mass or more and 2.0% by mass or less.

### Manufacturing Method of Toner

The toner is obtained by manufacturing toner particles and then externally adding external additives to the toner particles. The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). These manufacturing methods are not particularly limited, and known manufacturing methods are adopted. Among the above methods, for example, the aggregation and coalescence method may be used for obtaining toner particles.

### Each Unit of Image Forming Apparatus

For example, it is preferable that the image forming apparatus according to the present exemplary embodiment includes an image holder, a charging unit that charges the surface of the image holder, an electrostatic charge image forming unit that forms an electrostatic charge image on the charged surface of the image holder, a developing unit that contains an electrostatic charge image developer and develops the electrostatic charge image formed on the surface of the image holder as a toner image by using the electrostatic charge image developer, a transfer unit that transfers the toner image formed on the surface of the image holder to the surface of a recording medium, and a fixing unit that fixes the toner image transferred to the surface of the recording medium.

In addition, for example, it is preferable that the image forming apparatus according to the present exemplary embodiment includes a developer cartridge that accommodates a replenishing developer containing the supply carrier B.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning unit that cleans the surface of the image holder before charging after the transfer of the toner image; and an apparatus including a charge neutralization unit that neutralizes charge by irradiating the surface of the image holder with charge neutralizing light before charging after the transfer of the toner image.

In the case where the image forming apparatus according to the present exemplary embodiment is the intermediate transfer-type apparatus, for example, a configuration is adopted which has an intermediate transfer member with surface on which the toner image will be transferred, a primary transfer unit that performs primary transfer to transfer the toner image formed on the surface of the image holder to the surface of the intermediate transfer member, and a secondary transfer unit that performs secondary transfer to transfer the toner image transferred to the surface of the intermediate transfer member to the surface of a recording medium.

In addition, examples of the image forming apparatus according to the present exemplary embodiment include an image forming apparatus including a developer cartridge that contains the replenishing developer containing the supply carrier B, an image holder, a charging device that charges a surface of the image holder, an electrostatic charge image forming device that forms an electrostatic charge image on the charged surface of the image holder, a developing device that contains a developer including the replenishing developer replenished from the developer cartridge and develops an electrostatic charge image formed on a surface of an image holder into a toner image by using the developer, a transfer device that transfers the toner image formed on the surface of the image holder to a surface of a recording medium, and a fixing device that fixes the toner image transferred to the surface of the recording medium.

An example of the image forming apparatus according to the present exemplary embodiment will be shown below, but the present invention is not limited thereto. Hereinafter, among the parts shown in the drawing, main parts will be described, and others will not be described.

An example of the image forming apparatus according to the present exemplary embodiment will be described with reference to the drawing.

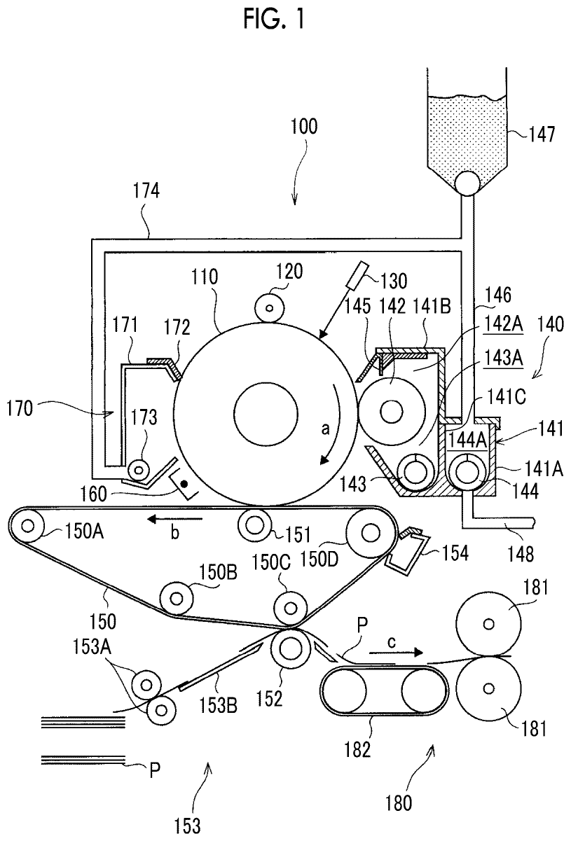

The image forming apparatus shown in FIG. 1 has a configuration adopting a trickle development type, in which a developer containing the supply carrier B is contained in the developer cartridge, the developer is supplied to the developer containing container in the developing device by a developer supplying unit, and at least a part of the developer contained in the developer containing container is discharged by a developer discharging unit.

The image forming apparatus shown in FIG. 1 has a configuration adopting a reclaim method, in which a residual toner remaining on the surface of the image holder is collected by a cleaning device, and then returned to the developing device for reuse.

An image forming apparatus 100 includes an image holder 110 that rotates clockwise indicated by an arrow a in FIG. 1; a charging device 120 that is provided above the image holder 110 so as to face the image holder 110 and negatively charges a surface of the image holder 110; an electrostatic charge image forming device 130 that forms an electrostatic charge image by writing an image to be formed with the developer (toner) on the surface of the image holder 110 charged by the charging device 120; a developing device 140 that is provided downstream of the electrostatic charge image forming device 130 and adheres the toner to the electrostatic charge image formed by the electrostatic charge image forming device 130 to form a toner image on the surface of the image holder 110; an endless intermediate transfer belt 150 that runs in a direction indicated by an arrow b while being contact with the image holder 110 and transfers the toner image formed on the surface of the image holder 110; a neutralization device 160 that neutralizes the surface of the image holder 110 after the toner image has been transferred to the intermediate transfer belt 150 to facilitate removal of a residual toner remaining on the surface; a cleaning device 170 that removes and collects the residual toner on the surface of the image holder 110 as a residual toner removing unit; and a residual toner transporting unit 174 that transports the residual toner removed and collected by the cleaning device 170 and supplies the residual toner to the developing device 140.

The charging device 120, the electrostatic charge image forming device 130, the developing device 140, the intermediate transfer belt 150, the neutralization device 160, and the cleaning device 170 are arranged in a clockwise direction on a circumference surrounding the image holder 110.

The intermediate transfer belt 150 is held in a state of being tensioned by support rolls 150A and 150B, a back roll 150C, and a driving roll 150D from the inside, and is driven in the direction of the arrow b as the driving roll 150D rotates. At a position facing the image holder 110 inside the intermediate transfer belt 150, a primary transfer roll 151 is provided to positively charge the intermediate transfer belt 150 and adsorb the toner on the image holder 110 to an outer surface of the intermediate transfer belt 150. On the outer side below the intermediate transfer belt 150, a secondary transfer roll 152, that transfers the toner image formed on the intermediate transfer belt 150 onto a recording paper P by positively charging the recording paper P and pressing the recording paper P against the intermediate transfer belt 150, is provided facing the back roll 150C.

Further, below the intermediate transfer belt 150, a recording medium supplying device 153 that supplies the recording paper P to the secondary transfer roll 152, and a fixing device 180 that fixes the toner image while transporting the recording paper P on which the toner image is formed on the secondary transfer roll 152 are provided.

The recording medium supplying device 153 includes a pair of transfer rolls 153A, and an induction slope 153B that guides the recording paper P transported by the transfer rolls 153A toward the secondary transfer roll 152. On the other hand, the fixing device 180 includes a fixing roll 181 that is a pair of heat rolls and fixes the toner image by heating and pressing the recording paper P onto which the toner image has been transferred by the secondary transfer roll 152, and a transporting conveyor 182 that transports the recording paper P toward the fixing roll 181.

The recording paper P is transported in a direction indicated by an arrow c by the recording medium supplying device 153, the secondary transfer roll 152, and the fixing device 180.

An intermediate transfer member cleaning device 154 that has a cleaning blade for removing the toner remaining on the intermediate transfer belt 150 after the toner image has been transferred to the recording paper P by the secondary transfer roll 152 is provided to be arranged to face the driving roll 150D with the intermediate transfer belt 150 interposed therebetween.

Hereinafter, the developing device 140 will be described in detail. The developing device 140 is disposed to face the image holder 110 in a developing region, and for example, includes a developer containing container 141 that contains a two-component developer containing a negative (−) charged toner and a positive (+) charged carrier. The developer containing container 141 includes a developer containing container main body 141A and a developer containing container cover 141B that closes an upper end of the developer containing container main body 141A.

The developer containing container main body 141A includes a developing roll chamber 142A containing a developing roll 142 inside the developer containing container main body 141A, and includes, adjacent to the developing roll chamber 142A, a first stirring chamber 143A and a second stirring chamber 144A adjacent to the first stirring chamber 143A. In addition, in the developing roll chamber 142A, a layer thickness restricting member 145 for restricting a layer thickness of the developer on the surface of the developing roll 142 at a time when the developer containing container cover 141B is mounted on the developer containing container main body 141A is provided.

The first stirring chamber 143A and the second stirring chamber 144A are partitioned by a partition wall 141C, and although not shown, the first stirring chamber 143A and the second stirring chamber 144A are communicated at both end parts in a longitudinal direction (longitudinal direction of the developing device) of the partition wall 141C. In addition, the first stirring chamber 143A and the second stirring chamber 144A constitute a circulation stirring chamber (143A+144A).

In the developing roll chamber 142A, the developing roll 142 is disposed to face the image holder 110. Although not shown, the developing roll 142 has a sleeve provided on an outer side of a magnetic roll (fixed magnet) having magnetism. The developer in the first stirring chamber 143A is adsorbed to the surface of the developing roll 142 by a magnetic force of the magnetic roll, and is transported to the developing region. In addition, a roll shaft of the developing roll 142 is rotatably supported by the developer containing container main body 141A. Here, the developing roll 142 and the image holder 110 rotate in opposite directions, and in the opposite portion, the developer adsorbed on the surface of the developing roll 142 is transported to the developing region in the same direction as a traveling direction of the image holder 110.

In addition, the sleeve of the developing roll 142 is connected to a bias power supply (not shown) so that a predetermined developing bias is applied (in the present exemplary embodiment, a bias in which an alternating current component (AC) is superimposed on a direct current component (DC) is applied so that an alternating electric field is applied to the developing region).

In the first stirring chamber 143A and the second stirring chamber 144A, a first stirring member 143 (stirring and transporting member) and a second stirring member 144 (stirring and transporting member) that transport the developer while stirring are arranged. The first stirring member 143 is configured by a first rotating shaft extending in an axial direction of the developing roll 142 and a stirring and transporting blade (projection portion) spirally fixed to an outer periphery of the rotating shaft. Similarly, the second stirring member 144 is also configured by a second rotating shaft and a stirring and transporting blade (projection portion). The stirring members are rotatably supported by the developer containing container main body 141A. The first stirring member 143 and the second stirring member 144 are arranged such that the developer in the first stirring chamber 143A and the second stirring chamber 144A is transported in the opposite directions by a rotation thereof.

One end of a developer supplying unit 146 for supplying the replenishing developer to the second stirring chamber 144A is connected to one end in the longitudinal direction of the second stirring chamber 144A, and the other end of the developer supplying unit 146 is connected to a developer cartridge 147 containing the replenishing developer. In addition, one end of a developer discharging unit 148 for discharging the contained developer is also connected to the one end in the longitudinal direction of the second stirring chamber 144A, and the other end of the developer discharging unit 148 is connected to a developer collecting container (not shown) for collecting the discharged developer.

As described above, the developing device 140 supplies the replenishing developer from the developer cartridge 147 to the developing device 140 (the second stirring chamber 144A) through the developer supplying unit 146, and discharges old developer to the developer discharging unit 148, that is, a trickle development method is adopted as the developing device 140. Specifically, in order to suppress deterioration of charging performance of the developer and extend the period of developer replacement, the trickle development method is a development method in which the replenishing developer (trickle developer) is gradually supplied into the developing device, and developing is performed while discharging excess deteriorated developer (that contains a large amount of deteriorated carrier).

Next, the cleaning device 170 will be described in detail. The cleaning device 170 includes a housing 171 and a cleaning blade 172 that is disposed to project from the housing 171. The cleaning blade 172 has a plate-like shape extending in an axial direction of a rotation axis of the image holder 110, and is provided such that a leading end (edge portion) of the image holder 110 is in contact with a transfer position of the primary transfer roll 151 on the downstream side in the rotational direction (direction of arrow a), and is in contact with the downstream side in the rotational direction from the position where electricity is neutralized by a neutralization device 160.

In the cleaning blade 172, as the image holder 110 rotates in the direction of the arrow a, foreign matter such as the residual toner adhering to the image holder 110 without being transferred to the intermediate transfer belt 150 by the primary transfer roll 151 is dammed up and removed from the image holder 110.

In addition, a transporting member 173 is disposed at a bottom of the housing 171, and one end of the residual toner transporting unit 174 for transporting the residual toner (developer) removed by the cleaning blade 172 and connected, and supplying the residual toner to the developing device 140 is connected to the downstream side of the transporting member 173 in the transporting direction of the housing 171. The other end of the residual toner transporting unit 174 is connected to join the developer supplying unit 146.

As described above, the cleaning device 170 transports the residual toner to the developing device 140 (second stirring chamber 144A) through the residual toner transporting unit 174 as the transporting member 173 provided at the bottom of the housing 171 rotates, and stirs and transports the residual toner collected from the surface of the image holder 110 together with the developer (toner) contained in the developing device 140 for reuse.

### Image Forming Method

The image forming method according to the present exemplary embodiment is an image forming method of a trickle development type, in which a two-component developer containing a toner and a carrier A is accommodated in a developing machine and a toner is supplied together with a supply carrier B in response to a toner consumed by development, in which the carrier A has a magnetic core material A and a resin coating layer A coating the magnetic core material A, where the resin coating layer A contains no metal oxide particles, and the supply carrier B has a magnetic core material B and a resin coating layer B coating the magnetic core material B, where the resin coating layer B contains metal oxide particles.

In addition, in the image forming method according to the present exemplary embodiment, for example, it is preferable to use the image forming apparatus according to the present exemplary embodiment.

In the image forming method of the related art, a developing type, so-called trickle type has been introduced in which a developing device that suppresses a change in charge amount and stabilizes an image density by adding a carrier together with a toner consumed by development and gradually replacing the carrier in the developing machine is used.

In the image forming method of the related art using the trickle type, in a case where the supply carrier is added, a deteriorated carrier and a non-deteriorated supply carrier are discharged at a proportion of 1:1, and the deteriorated carrier is gradually replaced with the supply carrier at a constant ratio.

In the image forming method of the related art, particularly in a case of low image quality density and low number of sheets printing in which the toner consumption amount is extremely low, time for a contaminated carrier to be discharged is required, that may deteriorate an initial decrease in charge of the developer, and thus fogging may occur.

In the image forming method according to the present exemplary embodiment, since the carrier A accommodated in the developing machine has the magnetic core material A and the resin coating layer A coating the magnetic core material A, and does not contain metal oxide particles in the resin coating layer A, and the supply carrier B has the magnetic core material B and the resin coating layer B coating the magnetic core material B, and contains metal oxide particles in the resin coating layer B, a difference in fluidity of carriers occurs by adding the supply carrier B that is a high-reliability carrier having high fluidity to the carrier A that is a deteriorated carrier having low fluidity, the carrier A having poor fluidity is selectively discharged, the decrease in charge of the developer is suppressed, and the toner fogging is suppressed.

Aspects of the toner, the carrier A, the supply carrier B, the magnetic core material A, the resin coating layer A, the magnetic core material B, the resin coating layer B, and the metal oxide particles in the image forming method according to the present exemplary embodiment are the same as the aspects of the toner, the carrier A, the supply carrier B, the magnetic core material A, the resin coating layer A, the magnetic core material B, the resin coating layer B, and the metal oxide particles in the image forming apparatus according to the present exemplary embodiment described above.

Examples of the image forming method according to the present exemplary embodiment include a method including a charging step of charging a surface of an image holder, an electrostatic charge image forming step of forming an electrostatic charge image on the charged surface of the image holder; a developing step of developing an electrostatic charge image formed on a surface of the image holder as a toner image by using a developer containing the supply carrier B and is replenished from a developer cartridge, a transfer step of transferring the toner image formed on the surface of the image holder to a surface of a recording medium, and fixing the toner image transferred to the surface of the recording medium.

In addition, the image forming method according to the present exemplary embodiment may be an intermediate transfer method in which the toner image formed on the surface of the image holder is subjected to primary transfer to the surface of the intermediate transfer member, and the toner image transferred to the surface of the intermediate transfer member is subjected to secondary transfer to the surface of the recording medium.

Furthermore, the image forming method according to the present exemplary embodiment may include a cleaning step of cleaning the surface of the image holder before charge, after the transfer of the toner image.

In addition, the image forming method according to the present exemplary embodiment may include a de-electrification step of irradiating the surface of the image holder with de-electrification light to de-electrify the surface before charge, after the transfer of the toner image.

### EXAMPLES

Hereinafter, the present exemplary embodiments will be specifically described based on Examples. However, the present exemplary embodiments are not limited to Examples. In the following description, unless otherwise specified, “parts” and “%” are based on mass.

### Volume-Average Particle Size of Carrier

The toner is removed from the electrostatic charge image developer by air blowing using any mesh, and the carrier is taken out. The particle size distribution of the carrier is measured using a laser diffraction/scattering-type particle size distribution analyzer (LS Particle Size Analyzer; LS13 320, manufactured by Beckman Coulter, Inc.). For the particle size range (channel) divided using the obtained particle size distribution, a volume-based cumulative distribution is plotted from the small-sized particle side, and a particle size at which the cumulative percentage reaches 50% is adopted as the volume-average particle size D50.

### Production of Toner

### Preparation of Resin Particle Dispersion (1)

Ethylene glycol (manufactured by FUJIFILM Wako Pure Chemical Corporation): 37 parts
Neopentyl glycol (manufactured by FUJIFILM Wako Pure Chemical Corporation): 65 parts
1,9-Nonanediol (manufactured by FUJIFILM Wako Pure Chemical Corporation): 32 parts
Terephthalic acid (manufactured by FUJIFILM Wako Pure Chemical Corporation): 96 parts

The above-described materials are put in a flask, the temperature is raised to 200° C. for 1 hour, and after it is confirmed that the inside of the reaction system is uniformly agitated, 1.2 parts of dibutyltin oxide is added. The temperature is raised to 240° C. for 6 hours in a state where the generated water is distilled off, and stirring is continued at 240° C. for 4 hours, thereby obtaining a polyester resin (acid value: 9.4 mgKOH/g, weight-average molecular weight: 13,000, glass transition temperature: 62° C.). The polyester resin in a molten state is transferred to an emulsifying disperser (CAVITRON CD1010, Eurotech Ltd.) at a rate of 100 g/min. Separately, dilute aqueous ammonia having a concentration of 0.37% obtained by diluting the reagent aqueous ammonia with deionized water is put in a tank and transferred to an emulsifying disperser together with the polyester resin at a rate of 0.1 L/min while being heated at 120° C. by a heat exchanger. The emulsifying disperser is operated under the conditions of a rotation speed of a rotor of 60 Hz and a pressure of 5 kg/cm², thereby obtaining a resin particle dispersion (1) having a volume-average particle size of 160 nm and a solid content of 30%.

### Preparation of Resin Particle Dispersion (2)

Decanedioic acid (manufactured by Tokyo Chemical Industry Co., Ltd.): 81 parts
Hexandiol (manufactured by FUJIFILM Wako Pure Chemical Corporation): 47 parts

The above-described materials are put in a flask, the temperature is raised to 160° C. for 1 hour, and after it is confirmed that the inside of the reaction system is uniformly agitated, 0.03 parts of dibutyltin oxide is added. While the generated water is distilled off, the temperature is raised to 200° C. for 6 hours, and agitating is continued for 4 hours at 200° C. Thereafter, the reaction solution is cooled, solid-liquid separation is performed, and the solid is dried at a temperature of 40° C. under reduced pressure, thereby obtaining a polyester resin (C1) (melting point: 64° C., weight-average molecular weight: 15,000).
Polyester resin (C1): 50 parts
Anionic surfactant (NEOGEN SC, manufactured by DKS Co. Ltd.): 2 parts
Deionized water: 200 parts

The above-described materials are heated to 120° C., thoroughly dispersed with a homogenizer (ULTRA-TURRAX T50, IKA), and then subjected to a dispersion treatment with a pressure jet-type homogenizer. At a point in time when the volume-average particle size reaches 180 nm, the dispersed resultant is collected, thereby obtaining a resin particle dispersion (2) having a solid content of 20%.

### Preparation of Colorant Particle Dispersion (1)

Cyan pigment (PigmentBlue 15:3, manufactured by Dainichiseika Color & Chemicals Mfg. Co., Ltd.): 10 parts
Anionic surfactant (NEOGEN SC, manufactured by DKS Co. Ltd.): 2 parts
Deionized water: 80 parts

The above-described materials are mixed together and dispersed for 1 hour with a high-pressure impact disperser ULITMIZER (HJP30006, manufactured by SUGINO MACHINE LIMITED), thereby obtaining a colorant particle dispersion (1) having a volume-average particle size of 180 nm and a solid content of 20%.

### Preparation of Release Agent Particle Dispersion (1)

Paraffin wax (HNP-9, manufactured by NIPPON SEIRO CO., LTD.): 50 parts
Anionic surfactant (NEOGEN SC, manufactured by DKS Co. Ltd.): 2 parts
Deionized water: 200 parts

The above-described materials are heated to 120° C., thoroughly dispersed with a homogenizer (ULTRA-TURRAX T50, IKA), and then subjected to a dispersion treatment with a pressure jet-type homogenizer. At a point in time when the volume-average particle size reaches 200 nm, the dispersed resultant is collected, thereby obtaining a release agent particle dispersion (1) having a solid content of 20%.

### Production of Toner (1)

Resin particle dispersion (1): 150 parts
Resin particle dispersion (2): 50 parts
Colorant particle dispersion (1): 25 parts
Release agent particle dispersion (1): 35 parts
Polyaluminum chloride: 0.4 parts
Deionized water: 100 parts

The above-described materials are put in a round stainless steel flask, thoroughly mixed and dispersed together by using a homogenizer (ULTRA-TURRAX T50, IKA), and then heated to 48° C. in an oil bath for heating in a state where the inside of the flask is stirred. The internal temperature of the reaction system is kept at 48° C. for 60 minutes, and then 70 parts of the resin particle dispersion (1) is slowly added thereto. Next, the pH is adjusted to 8.0 by using a 0.5 mol/L sodium hydroxide aqueous solution, the flask is then sealed, heated to 90° C. while being continuously stirred with a stirring shaft with a magnetic seal, and kept at 90° C. for 30 minutes. Next, the mixture is cooled at a cooling rate of 5° C./min, subjected to solid-liquid separation, and thoroughly washed with deionized water. Next, the mixture is subjected to solid-liquid separation, redispersed in deionized water at 30° C., and stirred and washed at a rotation speed of 300 revolutions per minute (rpm) for 15 minutes. The washing operation is further repeated 6 times, solid-liquid separation is performed at a point in time when the pH of the filtrate reaches 7.54 and the electrical conductivity reaches 6.5 μS/cm, and vacuum drying is continued for 24 hours, thereby obtaining toner particles having a volume-average particle size of 5.7 μm.

100 parts of the above-described toner particles and 2.5 parts of silica particles (treated with hexamethyldisilazane for surface hydrophobization, average primary particle size: 40 nm) are mixed with a Henschel mixer to obtain a toner (1).

### Production of Ferrite Particles (1)

1318 parts of Fe₂O₃, 587 parts of Mn(OH)₂, and 96 parts of Mg(OH)₂ are mixed with each other, and the mixture is subjected to temporary firing at a temperature of 900° C. for 4 hours. The temporary-fired product, 6.6 parts of polyvinyl alcohol, 0.5 parts of polycarboxylic acid as a dispersant, and zirconia beads having a medium diameter of 1 mm are put into water, and pulverized and mixed with a sand mill to obtain a dispersion. A volume-average particle size of the particles in the dispersion is 1.5 μm.

The dispersion is used as a raw material, and granulated and dried with a spray dryer to obtain a granular substance having a volume-average particle size of 37 μm. Next, main firing is performed at a temperature of 1450° C. for 4 hours using an electric furnace in an oxygen-nitrogen mixed atmosphere with an oxygen partial pressure of 1%, and then heating is performed in the atmosphere at a temperature of 900° C. for 3 hours to obtain fired particles. The fired particles are crushed and classified to obtain ferrite particles (1) having a volume-average particle size of 35 μm.

### Production of Metal Oxide Particles to be Added Inside Carrier Resin Coating Layer

Commercially available silica particles (volume-average particle size: 7 nm, specific gravity: 2.2, fumed silica particles surface-treated with hexamethyldisilazane, manufactured by Tokuyama Corporation, product name: HM30S) are prepared and used as metal oxide particles (1).

### Metal Oxide Particles (2)

890 parts of methanol and 210 parts of 9.8% aqueous ammonia are charged and mixed in a 1.5 L glass reaction container equipped with a stirrer, a dropping nozzle, and a thermometer to obtain an alkali catalyst solution. After adjusting the alkali catalyst solution to 45° C., 550 parts of tetramethoxysilane and 140 parts of 7.6% aqueous ammonia are simultaneously added dropwise thereto over 450 minutes with stirring, thereby obtaining a silica particle dispersion (A). Silica particles in the silica particle dispersion (A) have a volume-average particle size of 5 nm and a volume particle size distribution index (½ of square root (D84v/D16v) of a ratio of a particle size D84v at a cumulative percentage of 84% to a particle size D16v at a cumulative percentage of 16% in a volume-based particle size distribution on the small diameter side) of 1.2.

300 parts of the silica particle dispersion (A) are put into an autoclave equipped with a stirrer, and the stirrer is rotated at a rotation speed of 100 rpm. While continuing the rotation of the stirrer, liquefied carbon dioxide is injected into the autoclave from a carbon dioxide cylinder through a pump, the pressure is increased by the pump while the inside of the autoclave is heated with a heater, and the inside of the autoclave is brought into a supercritical state at 150° C. and 15 MPa. The pressure valve is operated to allow the supercritical carbon dioxide to flow while maintaining the inside of the autoclave at 15 MPa, and methanol and water are removed from the silica particle dispersion (A). The supply of carbon dioxide is stopped at a time point when the amount of carbon dioxide supplied into the autoclave reaches 900 parts, and a powder of silica particles is obtained.

While the rotation of the stirrer of the autoclave is continued in a state where the inside of the autoclave is maintained at 150° C. and 15 MPa by the heater and the pump and the supercritical state of carbon dioxide is maintained, 50 parts of hexamethyldisilazane with respect to 100 parts of the silica particles is injected into the autoclave with an entrainer pump, and the inside of the autoclave is heated to 180° C. and reacted for 20 minutes. Next, the supercritical carbon dioxide is allowed to flow again in the autoclave to remove the excess hexamethyldisilazane. Next, the stirring is stopped, the pressure valve is opened to release the pressure in the autoclave to atmospheric pressure, and the temperature is lowered to room temperature (25° C.). In this way, silica particles surface-treated with hexamethyldisilazane are obtained. The silica particles have a volume-average particle size of 5 nm. The obtained silica particles are used as metal oxide particles (2).

### Metal Oxide Particles (3)

Silica particles surface-treated with hexamethyldisilazane are obtained by the same manner as in the production of the metal oxide particles (2), except that the dropwise addition amounts of the tetramethoxysilane and the 7.6% aqueous ammonia in the production of the silica particle dispersion (A) are adjusted to change the volume-average particle size of the silica particles in the silica particle dispersion to 70 nm. The silica particles have a volume-average particle size of 70 nm. The obtained silica particles are used as metal oxide particles (3).

### Metal Oxide Particles (4)

Silica particles surface-treated with hexamethyldisilazane are obtained by the same manner as in the production of the metal oxide particles (2), except that the dropwise addition amounts of the tetramethoxysilane and the 7.6% aqueous ammonia in the production of the silica particle dispersion (A) are adjusted to change the volume-average particle size of the silica particles in the silica particle dispersion to 3 nm. The silica particles have a volume-average particle size of 3 nm. The obtained silica particles are used as metal oxide particles (4).

### Metal Oxide Particles (5)

Silica particles surface-treated with hexamethyldisilazane are obtained by the same manner as in the production of the metal oxide particles (2), except that the dropwise addition amounts of the tetramethoxysilane and the 7.6% aqueous ammonia in the production of the silica particle dispersion (A) are adjusted to change the volume-average particle size of the silica particles in the silica particle dispersion to 85 nm. The silica particles have a volume-average particle size of 85 nm. The obtained silica particles are used as metal oxide particles (5).

### Metal Oxide Particles (6)

Silica particles surface-treated with hexamethyldisilazane are obtained by the same manner as in the production of the metal oxide particles (2), except that the dropwise addition amounts of the tetramethoxysilane and the 7.6% aqueous ammonia in the production of the silica particle dispersion (A) are adjusted to change the volume-average particle size of the silica particles in the silica particle dispersion to 2 nm. The silica particles have a volume-average particle size of 2 nm. The obtained silica particles are used as metal oxide particles (6).

### Metal Oxide Particles (7)

Silica particles surface-treated with hexamethyldisilazane are obtained by the same manner as in the production of the metal oxide particles (2), except that the dropwise addition amounts of the tetramethoxysilane and the 7.6% aqueous ammonia in the production of the silica particle dispersion (A) are adjusted to change the volume-average particle size of the silica particles in the silica particle dispersion to 86 nm. The silica particles have a volume-average particle size of 86 nm. The obtained silica particles are used as metal oxide particles (7).

### Metal Oxide Particles (8)

Silica particles surface-treated with hexamethyldisilazane are obtained by the same manner as in the production of the metal oxide particles (2), except that the dropwise addition amounts of the tetramethoxysilane and the 7.6% aqueous ammonia in the production of the silica particle dispersion (A) are adjusted to change the volume-average particle size of the silica particles in the silica particle dispersion to 30 nm. The silica particles have a volume-average particle size of 30 nm. The obtained silica particles are used as metal oxide particles (8).

### Metal Oxide Particles (9)

Silica particles surface-treated with methyltrimethoxysilane are obtained by the same manner as in the production of the metal oxide particles (2), except that the dropwise addition amounts of the tetramethoxysilane and the 7.6% aqueous ammonia in the production of the silica particle dispersion (A) are adjusted to change the volume-average particle size of the silica particles in the silica particle dispersion to 5 nm. The silica particles have a volume-average particle size of 5 nm. The obtained silica particles are used as metal oxide particles (9).

### Example 1

### Production of Supply Carrier B

### Production of Coating Agent for Forming Resin Coating Layer

Resin (1): 15.4 parts of cyclohexyl methacrylate polymer (weight-average molecular weight: 350,000)
Resin (2): 0.39 parts of 2-(dimethylamino)ethyl methacrylate polymer (weight-average molecular weight: 300,000)
Nitrogen-containing resin particles: 3.0 parts of melamine resin particles (EPOSTAR S (manufactured by NIPPON SHOKUBAI CO., LTD.))
Carbon black particles (1): 2.24 parts of carbon black (manufactured by Cabot Corporation, product name: VXC72)
Metal oxide particles (1): 7.0 parts of silica (volume-average particle size: 7 nm, specific gravity: 2.2, fumed silica particles surface-treated with hexamethyldisilazane, manufactured by Tokuyama Corporation, product name: HM30S)
Solvent: 300 parts of toluene

The above-described materials and glass beads (diameter: 1 mm, the same amount as toluene) are put in a sand mill and stirred at a rotation speed of 190 rpm for 30 minutes, thereby obtaining a coating agent (B1).

### Production of Carrier B1

1,000 parts of the ferrite particles (1) and 125 parts of the coating agent (B1) are put into a kneader and mixed at room temperature (25° C.) for 20 minutes. Next, the mixture is heated to 70° C. and dried under reduced pressure.

The dried product is cooled to room temperature (25° C.), and 125 parts of the coating agent (B1) are further added thereto and mixed at room temperature (25° C.) for 20 minutes. Next, the mixture is heated to 70° C. and dried under reduced pressure.

Next, the dried product is taken out of the kneader, and sieved with a mesh having an opening size of 75 μm to remove coarse powder, thereby obtaining a carrier B1 (supply carrier B).

### Production of Carrier A

### Production of Coating Agent for Forming Resin Coating Layer

Resin (1): 15.4 parts of cyclohexyl methacrylate polymer (weight-average molecular weight: 350,000)
Resin (2): 0.39 parts of 2-(dimethylamino)ethyl methacrylate polymer (weight-average molecular weight: 300,000)
Nitrogen-containing resin particles: 3.0 parts of melamine resin particles (EPOSTAR S (manufactured by NIPPON SHOKUBAI CO., LTD.))
Carbon black particles (1): 2.24 parts of carbon black (manufactured by Cabot Corporation, product name: VXC72)
Solvent: 300 parts of toluene

The above-described materials and glass beads (diameter: 1 mm, the same amount as toluene) are put in a sand mill and stirred at a rotation speed of 190 rpm for 30 minutes, thereby obtaining a coating agent (A1).

### Production of Carrier A1

1,000 parts of the ferrite particles (1) and 125 parts of the coating agent (A1) are put into a kneader and mixed at room temperature (25° C.) for 20 minutes. Next, the mixture is heated to 70° C. and dried under reduced pressure.

The dried product is cooled to room temperature (25° C.), and 125 parts of the coating agent (A1) are further added thereto and mixed at room temperature (25° C.) for 20 minutes. Next, the mixture is heated to 70° C. and dried under reduced pressure.

Next, the dried product is taken out of the kneader, and sieved with a mesh having an opening size of 75 μm to remove coarse powder, thereby obtaining a carrier A1 (carrier A).

### Production of Electrostatic Charge Image Developer A1

100 parts of the obtained carrier A1 and 9 parts of the toner (1) are charged into a V-blender and stirred for 20 minutes. Thereafter, the mixture is sieved through a sieve having an opening size of 212 μm to obtain an electrostatic charge image developer A1.

### Production of Electrostatic Charge Image Developer B1

8 parts of the obtained carrier B1 and 92 parts of the toner (1) are charged into a V-blender and stirred for 20 minutes. Thereafter, the mixture is sieved through a sieve having an opening size of 212 μm to obtain an electrostatic charge image developer B1.

### Production of Image Forming Apparatus

The electrostatic charge image developer A1 is put into a developing device of Docu Centre Color 450 (manufactured by FUJIFILM Business Innovation Corp.), and the electrostatic charge image developer B1 is put into a developer cartridge, thereby producing an image recording apparatus of Example 1.

### Comparative Example 1

### Production of Coating Agent for Forming Resin Coating Layer

Cyclohexyl methacrylate polymer (weight-average molecular weight: 350,000): 15.4 parts
2-(Dimethylamino)ethyl methacrylate polymer (weight-average molecular weight: 300,000): 0.39 parts
Melamine resin particles (EPOSTAR S (manufactured by NIPPON SHOKUBAI CO., LTD.)): 3.0 parts
Carbon black (manufactured by Cabot Corporation., product name: VXC72): 2.24 parts
Metal oxide particles (1): 9.0 parts of silica (volume-average particle size: 7 nm, specific gravity: 2.2, fumed silica particles surface-treated with hexamethyldisilazane, manufactured by Tokuyama Corporation, product name: HM30S)
Toluene: 300 parts

The above-described materials and glass beads (diameter: 1 mm, the same amount as toluene) are put in a sand mill and stirred at a rotation speed of 190 rpm for 30 minutes, thereby obtaining a coating agent (CA1).

### Production of Carrier CA1

1,000 parts of the ferrite particles (1) and the coating agent (CA1) are put into a vacuum degassing kneader, stirred at 70° C. and 80 kPa for 2 hours, the temperature is raised to 80° C., and toluene is distilled off at a degree of vacuum of 5 kPa to form a carrier coated with a resin. Subsequently, fine powder and coarse powder are removed by an elbow jet, thereby obtaining a carrier CA1.

An image forming apparatus is produced in the same manner as in Example 1, except that the carrier CA1 is used instead of the carrier A1.

### Comparative Example 2

An image forming apparatus is produced in the same manner as in Example 1, except that the carrier A1 and the carrier B1 are used in reverse order.

### Examples 2 to 9

An image forming apparatus is produced in the same manner as in Example 1, except that the metal oxide particles (1) are changed to the particles and the particle size described below and described in Table 1.
Example 2: alumina particles (manufactured by Evonik Industries AG, product name: AEROXIDE Alu C805)
Example 3: titania particles (manufactured by Evonik Industries AG, product name: TiO₂ T805)
Example 4: metal oxide particles (2)
Example 5: metal oxide particles (3)
Example 6: metal oxide particles (4)
Example 7: metal oxide particles (5)
Example 8: metal oxide particles (6)
Example 9: metal oxide particles (7)

### Examples 10 to 13

An image forming apparatus is produced in the same manner as in Example 1, except that the addition amount of the metal oxide particles (1) is changed to the content described in Table 1.

### Examples 14 to 17

An image forming apparatus is produced in the same manner as in Example 1, except that the amount of silica particles to be contained in the resin coating layer is adjusted to change the surface silica amount of the supply carrier B described above to the value of SiB/SiA described in Table 1.

### Examples 18 to 21

An image forming apparatus is produced in the same manner as in Example 1, except that the amounts of CB and the melamine resin particles with respect to the resin are changed to be the value of BETB/BETA described in Table 1.

### Example 22

The same image forming apparatus as in Example 1 is used, except that, in the production of the electrostatic charge image developer B1, the electrostatic charge image developer is prepared using 2 parts of the obtained carrier B1 and 98 parts of the toner (1).

### Example 23

The same image forming apparatus as in Example 1 is used, except that carriers A2 and B2 are produced by production methods in which the carbon black and the melamine resin particles are not added.

### Examples 24 and 25

An image forming apparatus is produced in the same manner as in Example 1, except that the metal oxide particles (1) are changed to the particles and the particle size described below and described in Table 1.
Example 24: metal oxide particles (8)
Example 25: metal oxide particles (9)

### Evaluation of Fogging Suppressing Property

Evaluation of the fogging suppressing property is performed as follows.

Using Docu Centre Color 450 (manufactured by FUJIFILM Business Innovation Corp.) produced in each of Examples and Comparative Examples, 2,000 sheets of image samples having an image density of 20% are printed on P paper in a high-temperature and high-humidity (28° C. and 85% RH) environment. Thereafter, in the same environment, 100 image samples having an image density of 1% are printed, and then the 100 th image sample having an image density of 1% is evaluated according to the following standard.

The presence or absence of fogging of the 100 th output image is observed with the naked eye and a loupe at a magnification of 5 times, and classified as follows.
A: no fogging is observed in all of the 10 sheets.
B: slight fogging is observed on one sheet with the loupe, that is not a problem.
C: a plurality of sheets have slight fogging are observed with the loupe, but the fogging is slight and does not affect the practical use.
C−: the fogging is visually recognized on one sheet, but is slight and does not affect the practical use.
D: a plurality of sheets have fogging are visually recognized, but the fogging is slight and does not affect the practical use.
E: all of the 10 sheets have visible fogging, that is not suitable for practical use.

The evaluation results are collectively shown in Table 1.

TABLE 1

| | | | Metal oxide particles in supply | | | | | | |
|---|---|---|---|---|---|---|---|---|---|
| | | | carrier B | | | | | | |
| | | | | | Content | | | | |
| | | | | | with | | | | |
| | | | | | respect to | | | | |
| | | | | Volume- | resin | | | | |
| | | | | average | coating | | | Trickle | Evaluation |
| | | | | particle | layer | | | amount | of fogging |
| | | Supply | | size | (% by | SiB/ | BETB/ | (% by | suppressing |
| | Carrier A | carrier B | Type | (nm) | mass) | SiA | BETA | mass) | property |
| Example 1 | A1 | B1 | Silica | 7 | 30 | 3 | 2 | 8 | A |
| Comparative | CA1 | B1 | Silica | 7 | 30 | 3 | 2 | 8 | E |
| Example 1 | | | | | | | | | |
| Comparative | B1 | A1 | Silica | 7 | 30 | 3 | 2 | 8 | E |
| Example 2 | | | | | | | | | |
| Example 2 | A1 | B2 | Alumina | 22 | 30 | 3 | 2 | 8 | D |
| Example 3 | A1 | B3 | Titania | 21 | 30 | 3 | 2 | 8 | D |
| Example 4 | A1 | B4 | Silica | 5 | 30 | 3 | 2 | 8 | B |
| Example 5 | A1 | B5 | Silica | 70 | 30 | 3 | 2 | 8 | B |
| Example 6 | A1 | B6 | Silica | 3 | 30 | 3 | 2 | 8 | C |
| Example 7 | A1 | B7 | Silica | 85 | 30 | 3 | 2 | 8 | C |
| Example 8 | A1 | B8 | Silica | 2 | 30 | 3 | 2 | 8 | C- |
| Example 9 | A1 | B9 | Silica | 86 | 30 | 3 | 2 | 8 | C- |
| Example 10 | A1 | B1 | Silica | 7 | 10 | 3 | 2 | 8 | A |
| Example 11 | A1 | B1 | Silica | 7 | 60 | 3 | 2 | 8 | A |
| Example 12 | A1 | B1 | Silica | 7 | 5 | 3 | 2 | 8 | C |
| Example 13 | A1 | B1 | Silica | 7 | 70 | 3 | 2 | 8 | C |
| Example 14 | A1 | B10 | Silica | 7 | 30 | 1.2 | 2 | 8 | B |
| Example 15 | A1 | B11 | Silica | 7 | 30 | 5 | 2 | 8 | B |
| Example 16 | A1 | B12 | Silica | 7 | 30 | 1 | 2 | 8 | C |
| Example 17 | A1 | B13 | Silica | 7 | 30 | 8 | 2 | 8 | C |
| Example 18 | A1 | B14 | Silica | 7 | 30 | 3 | 0.5 | 8 | B |
| Example 19 | A1 | B15 | Silica | 7 | 30 | 3 | 8 | 8 | B |
| Example 20 | A1 | B16 | Silica | 7 | 30 | 3 | 0.2 | 8 | C |
| Example 21 | A1 | B17 | Silica | 7 | 30 | 3 | 10 | 8 | C |
| Example 22 | A1 | B1 | Silica | 7 | 30 | 3 | 2 | 2 | C |
| Example 23 | A2 | B2 | Silica | 7 | 30 | 3 | 1 | 8 | C |
| Example 24 | A1 | B1 | Silica | 30 | 30 | 3 | 2 | 8 | A |
| Example 25 | A1 | B4 | Silica | 5 | 30 | 3 | 2 | 8 | B |

As shown in Table 1, the image forming apparatuses and the image forming methods of Examples 1 to 25 are excellent in fogging suppressing property as compared with the image forming apparatuses and the image forming methods of Comparative Examples 1 and 2.
(((1))) An image forming apparatus of a trickle development type, in which a two-component developer containing a toner and a carrier A is accommodated in a developing machine and a toner is supplied together with a supply carrier B in response to a toner consumed by development,
wherein the carrier A has a magnetic core material A and a resin coating layer A coating the magnetic core material A, where the resin coating layer A contains no metal oxide particles, and
the supply carrier B has a magnetic core material B and a resin coating layer B coating the magnetic core material B, where the resin coating layer B contains metal oxide particles.
(((2))) The image forming apparatus according to (((1)),
wherein the metal oxide particles include at least one selected from the group consisting of silica particles, alumina particles, and titania particles.
(((3))) The image forming apparatus according to (((2))),
wherein the metal oxide particles include silica particles.
(((4))) The image forming apparatus according to any one of (((1))) to (((3))),
wherein a volume-average particle size D of the metal oxide particles is more than 3 nm and 85 nm or less.
(((5))) The image forming apparatus according to any one of (((1))) to (4))),
wherein a content of the metal oxide particles is 10% by mass or more and 60% by mass or less with respect to a total mass of the resin coating layer B.
(((6))) The image forming apparatus according to (((3)),
wherein a value of a ratio SiB/SiA of a surface silica amount SiB of the supply carrier B to a surface silica amount SiA of the carrier A is 1.2 or more and 5 or less.
(((7))) The image forming apparatus according to any one of (((1))) to 6)
wherein a value of a ratio BETB/BETA of a BET specific surface area BETB of the supply carrier B to a BET specific surface area BETA of the carrier A is 0.5 or more and 8 or less.
(((8))) An image forming method of a trickle development type, in which a two-component developer containing a toner and a carrier A is accommodated in a developing machine and a toner is supplied together with a supply carrier B in response to a toner consumed by development,
wherein the carrier A has a magnetic core material A and a resin coating layer A coating the magnetic core material A, where the resin coating layer A contains no metal oxide particles, and
the supply carrier B has a magnetic core material B and a resin coating layer B coating the magnetic core material B, where the resin coating layer B contains metal oxide particles.
(((9))) The image forming method according to (((8))),
wherein the metal oxide particles include at least one selected from the group consisting of silica particles, alumina particles, and titania particles.
(((10))) The image forming method according to (((9))),
wherein the metal oxide particles include silica particles.
(((11))) The image forming method according to any one of (((8))) to (((10))),
wherein a volume-average particle size D of the metal oxide particles is more than 3 nm and 85 nm or less.
(((12))) The image forming method according to any one of (((8))) to (((11))),
wherein a content of the metal oxide particles is 10% by mass or more and 60% by mass or less with respect to a total mass of the resin coating layer B.
(((13))) The image forming method according to (((10))),
wherein a value of a ratio SiB/SiA of a surface silica amount SiB of the supply carrier B to a surface silica amount SiA of the carrier A is 1.2 or more and 5 or less.
(((14))) The image forming method according to any one of (((8))) to (((13))),
wherein a value of a ratio BETB/BETA of a BET specific surface area BETB of the supply carrier B to a BET specific surface area BETA of the carrier A is 0.5 or more and 8 or less.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus of a trickle development type, in which a two-component developer containing a toner and a carrier A is accommodated in a developing machine and a toner is supplied together with a supply carrier B in response to a toner consumed by development,
wherein the carrier A has a magnetic core material A and a resin coating layer A coating the magnetic core material A, where the resin coating layer A contains no metal oxide particles, and
the supply carrier B has a magnetic core material B and a resin coating layer B coating the magnetic core material B, where the resin coating layer B contains metal oxide particles.

2. The image forming apparatus according to claim 1,
wherein the metal oxide particles include at least one selected from the group consisting of silica particles, alumina particles, and titania particles.

3. The image forming apparatus according to claim 2,
wherein the metal oxide particles include silica particles.

4. The image forming apparatus according to claim 1,
wherein a volume-average particle size D of the metal oxide particles is more than 3 nm and 85 nm or less.

5. The image forming apparatus according to claim 2,
wherein a volume-average particle size D of the metal oxide particles is more than 3 nm and 85 nm or less.

6. The image forming apparatus according to claim 1,
wherein a content of the metal oxide particles is 10% by mass or more and 60% by mass or less with respect to a total mass of the resin coating layer B.

7. The image forming apparatus according to claim 2,
wherein a content of the metal oxide particles is 10% by mass or more and 60% by mass or less with respect to a total mass of the resin coating layer B.

8. The image forming apparatus according to claim 3,
wherein a value of a ratio SiB/SiA of a surface silica amount SiB of the supply carrier B to a surface silica amount SiA of the carrier A is 1.2 or more and 5 or less.

9. The image forming apparatus according to claim 1,
wherein a value of a ratio BETB/BETA of a BET specific surface area BETB of the supply carrier B to a BET specific surface area BETA of the carrier A is 0.5 or more and 8 or less.

10. The image forming apparatus according to claim 2,
wherein a value of a ratio BETB/BETA of a BET specific surface area BETB of the supply carrier B to a BET specific surface area BETA of the carrier A is 0.5 or more and 8 or less.

11. An image forming method of a trickle development type, in which a two-component developer containing a toner and a carrier A is accommodated in a developing machine and a toner is supplied together with a supply carrier B in response to a toner consumed by development,
wherein the carrier A has a magnetic core material A and a resin coating layer A coating the magnetic core material A, where the resin coating layer A contains no metal oxide particles, and
the supply carrier B has a magnetic core material B and a resin coating layer B coating the magnetic core material B, where the resin coating layer B contains metal oxide particles.

12. The image forming method according to claim 11,
wherein the metal oxide particles include at least one selected from the group consisting of silica particles, alumina particles, and titania particles.

13. The image forming method according to claim 12,
wherein the metal oxide particles include silica particles.

14. The image forming method according to claim 11,
wherein a volume-average particle size D of the metal oxide particles is more than 3 nm and 85 nm or less.

15. The image forming method according to claim 12,
wherein a volume-average particle size D of the metal oxide particles is more than 3 nm and 85 nm or less.

16. The image forming method according to claim 11,
wherein a content of the metal oxide particles is 10% by mass or more and 60% by mass or less with respect to a total mass of the resin coating layer B.

17. The image forming method according to claim 12,
wherein a content of the metal oxide particles is 10% by mass or more and 60% by mass or less with respect to a total mass of the resin coating layer B.

18. The image forming method according to claim 13,
wherein a value of a ratio SiB/SiA of a surface silica amount SiB of the supply carrier B to a surface silica amount SiA of the carrier A is 1.2 or more and 5 or less.

19. The image forming method according to claim 11,
wherein a value of a ratio BETB/BETA of a BET specific surface area BETB of the supply carrier B to a BET specific surface area BETA of the carrier A is 0.5 or more and 8 or less.

20. The image forming method according to claim 12,
wherein a value of a ratio BETB/BETA of a BET specific surface area BETB of the supply carrier B to a BET specific surface area BETA of the carrier A is 0.5 or more and 8 or less.
